(19) United States
(12) Patent Application Publication
(10) Pub. No.: US 2026/0008917 A1
(43) Pub. Date: Jan. 8, 2026

(54) Polylactic Acid (PLA) / Polycarbonate (PC) Polymer Alloy and Method of Formation

(71) Applicant: Nano and Advanced Materials Institute Limited, Shatin (HK)

(72) Inventors: Wei Li, Shatin (HK); Kedi Li, Shatin (HK)

(21) Appl. No.: 18/884,602

(22) Filed: Sep. 13, 2024

Related U.S. Application Data
(60) Provisional application No. 63/668,415, filed on Jul. 8, 2024.

(51) Int. Cl. C08L 51/08; C08L 69/00

(52) U.S. Cl. CPC C08L 51/08; C08L 69/00; C08L 2205/06

(57) ABSTRACT

A polylactic acid (PLA)/polycarbonate (PC) polymer alloy includes polylactic acid/glycidyl methacrylate (PLA/GMA), an acrylate, an initiator, polylactic acid (PLA), and polycarbonate (PC).

### FIELD OF THE INVENTION

This invention relates to a polylactic acid (PLA)/polycarbonate (PC) polymer alloy, which may be used for the manufacture of electronic appliances and home appliances. Biobased PLA provides the environmental-friendly nature and PC provides protection to realize desired high toughness, heat resistance and durability. The formulation of the polymer alloy, method of formation, and biphasic plasticizer for manufacture of the polymer alloy are all parts of this invention.

### TECHNICAL BACKGROUND OF THE INVENTION

Due to increasing concern for environmental sustainability, more low carbon bio-based alternatives are used to replace petroleum-based plastic materials. Polylactic acid (PLA) is one of the most popular bio-based polymers derived from carbon renewable resources such as corn, which can be naturally recovered through biological processes, thereby reducing consumption of fossil fuels and emission of greenhouse gases. PLA has become a suitable environmentally-friendly polymer substitute for traditional plastics due to its excellent properties such as high tensile strength, high flexural strength, and high stiffness. Although PLA has been widely used for single-use products, such as plastic bags, etc., it is not suitable for use in tough and durable applications, such as electronic and home appliances, automotive interior trim components, etc., due to its intrinsic limitations.

TABLE 1
Comparison between polylactic acid (PLA) properties
and requirements of tough and durable applications

| Property | Requirements | PLA |
|---|---|---|
| Tensile Strength (MPa) | ≥60 | 50 |
| Flexural Strength (MPa) | ≥95 | 60 |
| Impact Strength (IZOD) | ≥15 | 1.3 |
| (kJ/m²) | | |
| Heat resistance: Vicat | ≥110 | 60 |
| Softening Temperature | | |
| (° C.) | | |
| Anti-aging | The above properties | Fail |
| (GB/T 7141) | pass the requirements | |
| | after the accelerated | |
| | test under 90° C. for | |
| | 1,000 hours | |

It can be seen from the above Table 1 that, generally speaking, PLA is:
(i) of poor toughness: PLA is brittle. Impact strength of PLA is only 1.3 KJ/m², which is only 8.7% of the required value of 15 KJ/m²;
(ii) of low heat resistance: Vicat softening temperature is low at around 60° C.; and
(iii) not durable: as PLA is (bio) degradable, its properties deteriorate easily under environmental stress, and is thus commonly considered to have durability not more than two years.

For improvement, researchers have been trying to form polylactic acid/polycarbonate (PLA/PC) alloy, aiming to utilize polycarbonate (PC) to protect PLA and remedy its intrinsic limitations. PC, as a typical engineering plastic, is commonly used in the fields of automobiles and electrical appliances due to its high thermal stability and impact resistance. However, PC is a petroleum-based plastic with high carbon footprint. Therefore, there has been an urgent need to develop a new material that has both excellent PC performance and low carbon footprint.

Due to the inherent superior toughness and heat deflection temperature of PC, incorporating PLA into PC is a promising method for preparing a polymer alloy with excellent mechanical properties. Nevertheless, due to the different polymer characteristics, it is difficult for the amorphous polymer chains of PC to break the crystalline phase of PLA. Even though some additives may be added to decrease the crystalline degree of PLA and make polymer chains of PLA and PC, a large amount of PC is still needed to ensure enough protection and provide better mechanical and thermal properties. It is reported that a lot of PC (˜90 wt. %) is needed to form the polymer alloy, which defeats the purpose of using bio-based PLA for carbon reduction.

This invention provides a method of forming a polylactic acid (PLA)/polycarbonate (PC) polymer alloy having both the environmentally-friendly nature of PLA and the desired high toughness, heat resistance and durability from the protection effect of PC. Specifically, a kind of biphasic plasticizer for effective interpenetration is used to realize clusterization induced phase inversion, which facilitates the PC to be in a continuous phase and provide protection effect.

### SUMMARY OF THE INVENTION

According to a first aspect of the present invention, there is provided a polylactic acid (PLA)/polycarbonate (PC) polymer alloy including polylactic acid/glycidyl methacrylate (PLA/GMA), an acrylate, an initiator, PLA, and PC.

According to a second aspect of the present invention, there is provided a biphasic plasticizer including polylactic acid (PLA), glycidyl methacrylate (GMA), and an acrylate.

According to a third aspect of the present invention, there is provided a method of forming a polylactic acid (PLA)/polycarbonate (PC) polymer alloy, including (a) mixing PLA and glycidyl methacrylate (GMA) to form polylactic acid/glycidyl methacrylate (PLA/GMA), and (b) mixing said PLA/GMA, an acrylate, an initiator, PLA and PC.

### BRIEF DESCRIPTION OF THE DRAWINGS

Embodiments of the present invention will now be described, by way of examples of only, with reference to the accompany drawings, in which:

FIG. 1 shows an exemplary route of synthesizing biphasic plasticizer PLA/GMA-co-EHA according to the present invention; and

FIG. 2 shows steps of formation of PLA/PC polymer alloy according to the present invention by clusterization induced phase inversion according to the present invention.

To facilitate effective blending of PLA and PC, interpenetration of polymer chains at the interface of both polymers is achieved by a biphasic plasticizer, namely, a polylactic acid/glycidyl methacrylate-co-acrylate (e.g., 2-ethylhexyl acrylate), PLA/GMA-co-EHA). It is designed to incorporate two different phase behaviors (PLA phase and EHA phase, respectively) on a single plasticizer. The PLA phase is miscible to the PLA polymer chains, while the EHA phase can immerse into and loosen the polymer chains of PC, which allows the PLA polymer chains to penetrate to them and thus yields a well-blended PLA/PC polymer alloy.

After modifying the continuous phase PLA to become the above biphasic plasticizer, e.g., PLA/GMA-co-EHA, the initiator, PLA and PC are mixed together by melt-blending in the second step. Due to the strong affinity among the similar PLA phase groups in the PLA/GMA-co-EHA molecules, they aggregate to form micelle-like spherical PLA clusters with the core built up by the PLA phase group “tail” and the outer surface to be covered by the EHA phase group “head”. Also, as PLA loses its mobility after aggregation, PC with high mobility changes to continuous phase to fill up the gaps between PLA/GMA-co-EHA clusters. Thus, phase inversion happens to form PLA/PC polymer alloy with PC as continuous phase to protect PLA. The material characteristics of this PLA/PC polymer alloy would behave like PC with high toughness, heat resistance and durability.

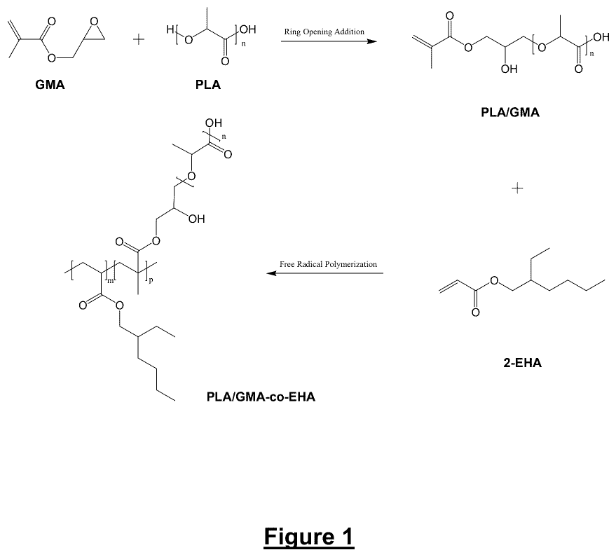

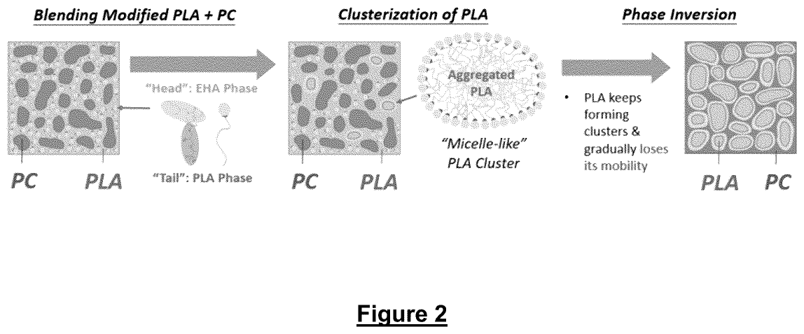

As shown in FIGS. 1 and 2, the biphasic plasticizer and PLA/PC polymer alloy may be prepared as follows:
a) PLA and PC are dried in ovens at 60-80° C. and 100-120° C. for 3-6 hours, respectively;
b) Mix PLA and GMA in a twin-screw extruder at 160-180° C. to attain PLA/GMA. The PLA/GMA comprises 85-99 wt. % of PLA and 1-15 wt. % of GMA;
c) Mix PLA/GMA (0.1-15 wt. %), an acrylate (such as butyl acrylate, hexyl acrylate, 2-ethylhexyl acrylate, dodecyl acrylate, or lauryl acrylate; 0.01-1 wt. %), an initiator (such as dicumyl peroxide, tert-butyl peroxybenzoate, benzoyl peroxide, di-tert-butyl peroxide, or cumyl hydroperoxide; 0.001-0.1 wt. %), PLA (10-90 wt. %) and PC (10-90 wt. %) in a twin-screw extruder at 210-240° C. PLA/GMA reacts with the acrylate (such as 2-ethylhexyl acrylate (EHA)) through a free radical polymerization process to form biphasic plasticizer PLA/GMA-co-EHA; and
d) Afterwards, PLA/PC polymer alloy is formed assisted by the biphasic plasticizer.

Examples 1, 3 and 5 illustrate polylactic acid (PLA)/polycarbonate (PC) polymer alloys and methods of forming the biphasic plasticizer and the PLA/PC polymer alloys according to the present invention, whereas Examples 2, 4, 6 and 7 are for comparison purposes.

### Example 1

A polymer blend was prepared as follows. Firstly, PLA and PC were dried in ovens at 70° C. and 110° C. for 4 hours, respectively. Then, PLA (85 wt. %) and GMA (15 wt. %) were mixed in a twin-screw extruder at 170° C. to attain PLA/GMA. Next, PLA/GMA (2 wt. %), 2-ethylhexyl acrylate (0.095 wt. %), dicumyl peroxide (0.005 wt. %), and PLA (48.3 wt. %) and PC (49.6 wt. %) were mixed in a twin-screw extruder at 230° C. Testing specimens of thus produced polymer blend were prepared with injection molding at 220° C.

The properties of the specimens of Example 1 are shown in Table 2, which are up to the requirements of tough and durable applications.

### Example 2

A polymer blend was prepared with completely identical formulation as that of Example 1, but without mixing PLA and GMA beforehand, but mixing all the components together in one step. Testing specimens of thus produced polymer blend were prepared with injection molding at 220° C.

The properties of the specimens of this Example are shown in Table 2. Compared to Example 1, direct mixing without synthesis of PLA-based plasticizer results in much lower mechanical properties in the specimens, which cannot meet the requirements of tough and durable applications.

### Example 3

A polymer blend was prepared as follows. Firstly, PLA and PC were dried in ovens at 70° C. and 110° C. for 4 hours, respectively. Then, PLA (85 wt. %) and GMA (15 wt. %) were mixed in a twin-screw extruder at 170° C. to attain PLA/GMA. Next, PLA/GMA (2 wt. %), 2-ethylhexyl acrylate (0.095 wt. %), dicumyl peroxide (0.005 wt. %), and PLA (58.3 wt. %) and PC (39.6 wt. %) were mixed in a twin-screw extruder at 230° C. Testing specimens of thus produced polymer blend were prepared with injection molding at 220° C.

The properties of the specimens under Example 3 are shown in Table 2, which are up to the requirements of tough and durable applications.

### Example 4

A polymer blend was prepared with completely identical formulation as that of Example 3, but without mixing PLA and GMA beforehand, but mixing all the components together in one step. Testing specimens of thus produced polymer blend were prepared with injection molding at 220° C.

The properties of the specimens are shown in Table 2. Compared to Example 3, direct mixing without synthesis of PLA-based plasticizer results in much lower mechanical properties of the specimens, which cannot meet the requirements of tough and durable applications.

### Example 5

A polymer blend was prepared as follows. Firstly, PLA and PC were dried in ovens at 70° C. and 110° C. for 4 hours, respectively. Then, PLA (85 wt. %) and GMA (15 wt. %) were mixed in a twin-screw extruder at 170° C. to attain PLA/GMA. Next, PLA/GMA (2 wt. %), 2-ethylhexyl acrylate (0.095 wt. %), dicumyl peroxide (0.005 wt. %), PLA (38.3 wt. %) and PC (59.6 wt. %) were mixed in a twin-screw extruder at 230° C. Testing specimens of thus produced polymer blend were prepared with injection molding at 220° C.

The properties of the specimens thus formed are shown in Table 2, which are up to the requirements of tough and durable applications.

### Example 6

A polymer blend was prepared with completely identical formulation as that of Example 3, without mixing PLA and GMA beforehand, but mixing all the components together in one step. Testing specimens of thus produced polymer blend were prepared with injection molding at 220° C.

The properties of the specimens thus formed are shown in Table 2. Compared to Example 5, direct mixing without synthesis of PLA-based plasticizer results in much lower mechanical properties of the specimens, which cannot meet the requirements of tough and durable applications.

### Example 7

A polymer blend was prepared by mixing PLA (50 wt. %) and PC (50 wt. %) in a twin-screw extruder at 230° C. Testing specimens of thus produced polymer blend were prepared with injection molding at 220° C.

The properties of the specimens are shown in Table 2. Compared with examples above, direct blending PLA and PC without applying any compatibilizer results in the poor toughness of the specimens, which cannot meet the requirements of tough and durable applications.

TABLE 2
Comparison between properties of examples and requirements of tough and durable applications

| | | Example | Example | Example | Example | Example | Example | Example |
|---|---|---|---|---|---|---|---|---|
| Property | Requirements | 1 | 2 | 3 | 4 | 5 | 6 | 7 |
| Tensile | ≥60 | 68.7 | 64.4 | 67.2 | 65.8 | 68.9 | 67.4 | 67.1 |
| Strength | | | | | | | | |
| (MPa) | | | | | | | | |
| Flexural | ≥95 | 101 | 85.1 | 95 | 80.2 | 103.8 | 89.1 | 84.6 |
| Strength | | | | | | | | |
| (MPa) | | | | | | | | |
| Impact | ≥15 | 86.7 | 17.2 | 48.8 | 7.9 | 113.2 | 25.2 | 6.7 |
| Strength | | | | | | | | |
| (IZOD) | | | | | | | | |
| (KJ/m²) | | | | | | | | |
| Heat | ≥110 | 130.2 | 115 | 116 | 100.7 | 142.3 | 130.0 | 114.8 |
| resistance: | | | | | | | | |
| Vicat | | | | | | | | |
| Softening | | | | | | | | |
| Temperature | | | | | | | | |
| (° C.) | | | | | | | | |
| Anti-aging | The above | Pass | Fail | Pass | Fail | Pass | Fail | Fail |
| (GB/T 7141) | properties | | | | | | | |
| | pass the | | | | | | | |
| | requirements | | | | | | | |
| | after the | | | | | | | |
| | accelerated | | | | | | | |
| | test under | | | | | | | |
| | 90° C. for | | | | | | | |
| | 1,000 hours | | | | | | | |

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided or separately or in any suitable sub-combination.

1. A polylactic acid (PLA)/polycarbonate (PC) polymer alloy including polylactic acid/glycidyl methacrylate (PLA/GMA), an acrylate, an initiator, PLA, and PC.

2. The polymer alloy of claim 1, wherein said PLA/GMA is of 0.1-15 wt. %.

3. The polymer alloy of claim 1, wherein said acrylate is of 0.01-1 wt. %.

4. The polymer alloy of claim 1, wherein said initiator is of 0.001-0.1 wt. %.

5. The polymer alloy of claim 1, wherein said PLA is of 10-90 wt. %.

6. The polymer alloy of claim 5, wherein said PLA is of more than 50 wt. %.

7. The polymer alloy of claim 1, wherein said PC is of 10-90 wt. %.

8. The polymer alloy of claim 1, wherein said acrylate is butyl acrylate, hexyl acrylate, 2-ethylhexyl acrylate, dodecyl acrylate, or lauryl acrylate.

9. The polymer alloy of claim 1, wherein said initiator is dicumyl peroxide, tert-butyl peroxybenzoate, benzoyl peroxide, di-tert-butyl peroxide, or cumyl hydroperoxide.

10. A biphasic plasticizer including polylactic acid (PLA), glycidyl methacrylate (GMA), and an acrylate.

11. The biphasic plasticizer of claim 10, wherein said acrylate is butyl acrylate, hexyl acrylate, 2-ethylhexyl acrylate, dodecyl acrylate, or lauryl acrylate.

12. The biphasic plasticizer of claim 10, wherein said biphasic plasticizer comprises polylactic acid/glycidyl methacrylate-co-2-ethylhexyl acrylate, (PLA/GMA-co-EHA).

13. A method of forming a polylactic acid (PLA)/polycarbonate (PC) polymer alloy, including:
(a) mixing PLA and glycidyl methacrylate (GMA) to form polylactic acid/glycidyl methacrylate (PLA/GMA), and
(b) mixing said PLA/GMA, an acrylate, an initiator, PLA and PC.

14. The method of claim 13, further including carrying out said step (a) and/or step (b) in a twin-screw extruder.

15. The method of claim 14, further including carrying out said step (a) at a temperature of over 150° C.

16. The method of claim 15, further including carrying out said step (a) at a temperature of 160° C.-180° C.

17. The method of claim 14, further including carrying out said step (b) at a temperature of over 200° C.

18. The method of claim 17, further including carrying out said step (b) at a temperature of 210-240° C.

19. The method of claim 13, wherein said initiator is dicumyl peroxide, tert-butyl peroxybenzoate, benzoyl peroxide, di-tert-butyl peroxide, or cumyl hydroperoxide.

20. The method of claim 13, wherein said acrylate is butyl acrylate, hexyl acrylate, 2-ethylhexyl acrylate, dodecyl acrylate, or lauryl acrylate.
